(19) United States
(12) Patent Application Publication
(10) Pub. No.: US 2009/0213082 A1
(43) Pub. Date: Aug. 27, 2009

(54) TOUCH PANEL WITH IMPROVED ELECTRODE PATTERN

(75) Inventor: Fu-Tien Ku, Taipei County (TW)

Correspondence Address: Muncy, Geissler, Olds & Lowe, PLLC, P.O. BOX 1364, FAIRFAX, VA, 22038-1364, US

(73) Assignee: DANOTECH CO., LTD.

(21) Appl. No.: 12/036,038

(22) Filed: Feb. 22, 2008

(51) Int. Cl. G06F 3/041

(52) U.S. Cl. 345/173

(57) ABSTRACT

A touch panel with an improved electrode pattern comprises: an insulating substrate; a conduction layer formed on the surface of the insulating substrate; and an electrode pattern formed on the surface of the conduction layer and arranged along the edges of the touch panel. The electrode pattern further comprises rows of parallel conductive silver traces, and each conductive silver trace has a plurality of electrodes having an identical length and equidistantly spaced. The present invention redesigns the number of the electrodes in each conductive silver trace and the relative position of each two neighboring conductive silver traces. Besides, the number of the electrodes in each conductive silver trace is calculated with an equation. Further, the present invention installs an additional conductive silver trace in the electrode pattern to eliminate the uneven impedance and electric field distributions caused by the print errors occurring in printing the conductive silver traces.

### FIELD OF THE INVENTION

The present invention relates to a touch panel with an improved electrode pattern, particularly to a touch panel with a modified electrode pattern arrangement in the edges of the touch panel.

### BACKGROUND OF THE INVENTION

According to the induction methods, the conventional touch panel may be classified into the resistive type, the capacitive type, the sonic type and the optical type. The resistive touch panel is the cheapest and most widely used one. However, the capacitive touch panel is acquiring more attention and adoption.

The resistive touch panel is essentially formed via stacking an upper ITO (Indium Tin Oxide) conduction layer over a lower ITO conduction layer, wherein pressure enables the conduction of the upper and lower electrodes at the contact point, and a controller will work out the coordinates of the contact point from the voltage variation of the touch panel and learn the input signal. A U.S. Pat. No. 4,822,957 about the resistive touch panel has been extensively used in the five-wire resistive touch panel of Elo Touch Company.

The capacitive touch panel has a glass substrate, and a conduction layer (such as a metal oxide layer) is formed on the glass substrate. An electrode pattern is formed on the surface of the conduction layer, and then a protective film is used to cover the electrode pattern. Voltage is provided from four corners of the panel, and the voltage forms electric field on the surface of the glass substrate via the electrode pattern. Finger's touching the panel will induce a current and result in voltage drop in the touched position. A controller works out the coordinates of the touched position from the ratios of the current to the four corners. U.S. Pat. No. 4,198,539, No. 4,293,734, No. 4,371,746 and No. 6,781,579 disclosed technologies of capacitive touch panels.

In general, a touch panel is evaluated with three parameters: the linear response of the electric field, the complexity of the electrode structure, and the width of the electrode pattern. The linear response of the electric field correlates with the accuracy of the touch panel. The complexity of the electrode structure correlates with the fabrication cost. The electrode pattern is arranged in the perimeter of the touch panel. Therefore, the width of the electrode pattern correlates with the available area of the touch panel. The electrode pattern consists of conductive silver traces (or called silver-glue wires) on the surface of the conduction layer. The higher the density and the smoother the density variation of the transparent electrodes, the smoother the density variation of the charges on the touch panel. The abovementioned principle can be used to modify the linearity of the electric field along the perimeter of the touch panel increasing the number of the conductive silver traces will obviously increase the impedance of the conductive silver traces at the four corners. The smaller the width of the frame formed by the conductive silver traces, the lower the impedance of the conductive silver traces. However, too low an impedance of the conductive silver traces will affect the operation of the controller of the touch panel.

Therefore, improving the linearity of the electric field of a touch panel, lowering the complexity of the electrode structure and decreasing the width of the electrode pattern are the objectives the designers and manufacturers of touch panels endeavor to achieve.

### SUMMARY OF THE INVENTION

One objective of the present invention is to provide an electrode pattern that can form a uniform low-voltage electric field.

To achieve the abovementioned objective, the present invention proposes a touch panel with an improved electrode pattern, which comprises: an insulating substrate, a conduction layer formed on the surface of the insulating substrate, and an electrode pattern formed on the surface of the conduction layer and arranged along the perimeter of the touch panel. The electrode pattern comprises several rows of conductive silver traces. Each conductive silver trace has a plurality of electrodes having an identical length and equidistantly spaced. The present invention improves the linearity of the electric field via redesigning the number of the electrodes in each conductive silver trace and the relative position of each two neighboring conductive silver traces.

Another objective of the present invention is to decrease the width of the electrode pattern to minimize the outer frame of a touch panel, increase the available area of the touch panel and expand the assembly space of the touch panel.

To achieve the abovementioned objective, the present invention redesigns the number of the electrodes in each conductive silver trace and the relative position of each two neighboring conductive silver traces, wherein the number of the electrodes in each conductive silver trace is calculated with an equation. Besides, the present invention additionally installs parallel-connection conductive silver traces to counterbalance the uneven distribution of impedance and electric field resulting from the print errors of the print process or the uneven surface impedance distribution of the ITO conduction layer.

### BRIEF DESCRIPTION OF THE DRAWINGS

FIG. 1 is a diagram schematically showing the structure of a capacitive touch panel.

FIG. 2 is a diagram schematically showing the relative position of the conductive silver traces according to a preferred embodiment of the present invention.

FIG. 3 is a diagram schematically showing the relative position of the conductive silver traces according to another preferred embodiment of the present invention.

FIG. 4 is a diagram showing the equivalent circuit of the conductive silver traces shown in FIG. 3.

FIG. 5 is a diagram schematically showing the distribution of the electric equipotential lines at one corner of the touch panel according to the preferred embodiment of the present invention shown in FIG. 3.

FIG. 6 is a diagram schematically showing the distribution of the electric equipotential lines of a US Pat. No. 6,781,579.

FIG. 7 is a diagram schematically showing the distribution of the electric equipotential lines of U.S. Pat. No. 4,198,539, No. 4,293,734 and No. 4,371,746.

### DETAILED DESCRIPTION OF THE PREFERRED EMBODIMENTS

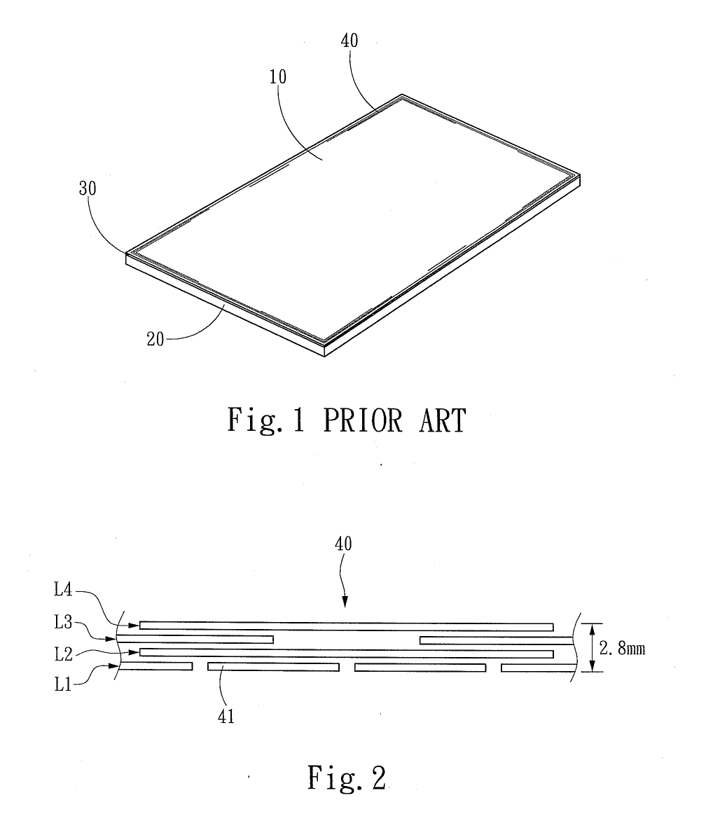

Refer to FIG. 1. In general, a capacitive touch panel 10 comprises:

an insulating substrate 20, such as a glass substrate;

a conduction layer 30 formed on the surface of the insulating substrate 20 (the conduction layer 30 is a metal oxide layer usually); and

an electrode pattern formed on the surface of the conduction layer 30 and arranged along the edges of the touch panel 10, wherein the electrode pattern further comprises rows of parallel conductive silver traces 40, and each conductive silver trace 40 has a plurality of electrodes 41 having an identical length and equidistantly spaced.

Refer to FIG. 2. Let X denote the total number of the rows of the conductive silver traces 40. Let L₁, L₂, L₃, L₄ respectively denote the conductive silver traces 40 in the sequence of from the one near the center of the touch panel 10 toward the one far away from the center. Let N denote the number of the electrodes 41 in one conductive silver trace 40. According to a first preferred embodiment of the present invention, N the number of the electrodes 41 is determined by from Equation 1 to Equation 4:

For Lₙ₌₁, N=2^{(X-n+2)}+1 (Equation 1)

For Lₙ₌₂, N=2^{(X-n+1)}+3 (Equation 2)

For Lₙ₌₃, N=2^{(X-n+2)}−1 (Equation 3)

For Lₙ₌₄, N=2^{(X-n+2)}+6 (Equation 4)

As shown in FIG. 2, in this embodiment, the total number of the rows of the conductive silver traces 40 is four, and the width of the electrode pattern is below 2.8mm. The conductive silver trace 40 most near the center of the touch panel 10 is denoted by L₁, and conductive silver traces 40 sequentially far away from the center are respectively denoted by L₂, L₃ and L₄. From the numbers of the electrodes 41 in the conductive silver traces L₁, L₂, L₃ and L₄ calculated from the abovementioned equations, the following rules are derived:

One electrode 41 in the conductive silver trace L₂ steps over four electrodes 41 in the conductive silver trace L₁.

One electrode 41 in the conductive silver trace L₃ steps over three electrodes 41 in the conductive silver trace L₂.

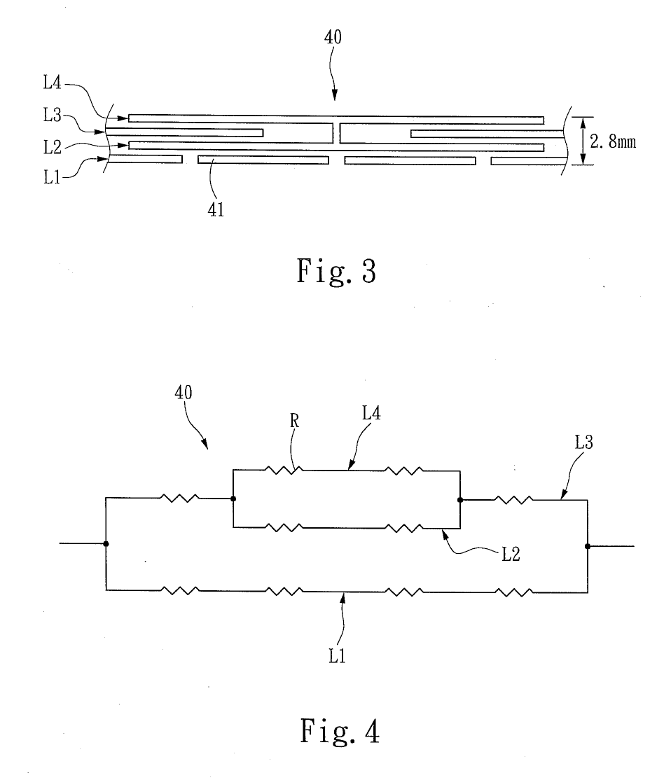

Refer to FIG. 3. The numbers of the electrodes 41 in the conductive silver traces L₁, L₂, L₃ and L₄ is still calculated from Equation 1 to Equation 4. However, an additional conductive silver trace 40 is formed in between each two electrodes 41 of the conductive silver trace L₃ to connect the conductive silver traces L₂ and L₄ and to implement a parallel connection of the conductive silver traces L₂ and L₄. Refer to FIG. 4 for a diagram showing the equivalent circuit of the parallel connection, wherein R denotes the impedance of the portion of the conduction layer 30 conducting electricity in between two neighboring electrodes 41 of a row of conductive silver trace 40. The parallel connection of the conductive silver traces L₂ and L₄ can reduce voltage drop to make the distribution of electric equipotential lines more uniform and counterbalance the print errors in printing the conductive silver traces 40 or the uneven surface impedance distribution of the ITO conduction layer.

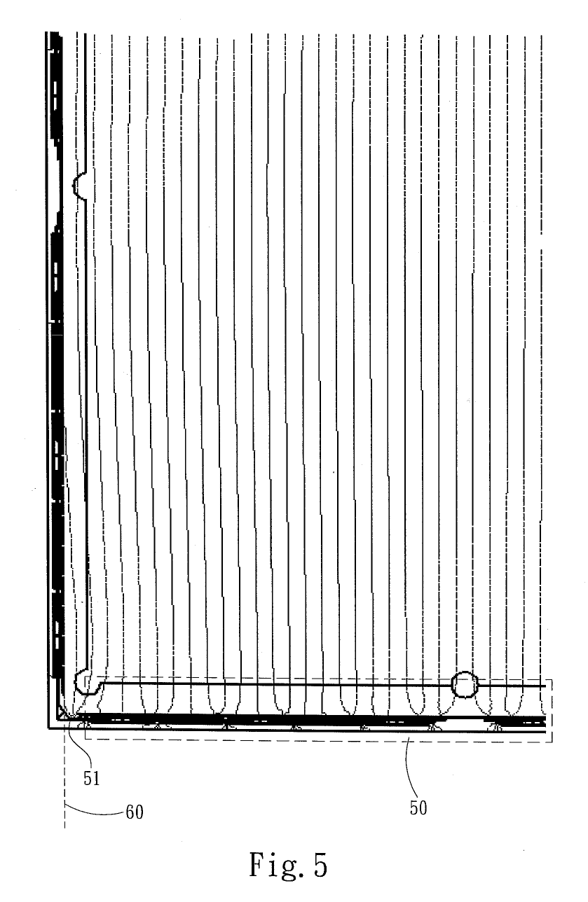

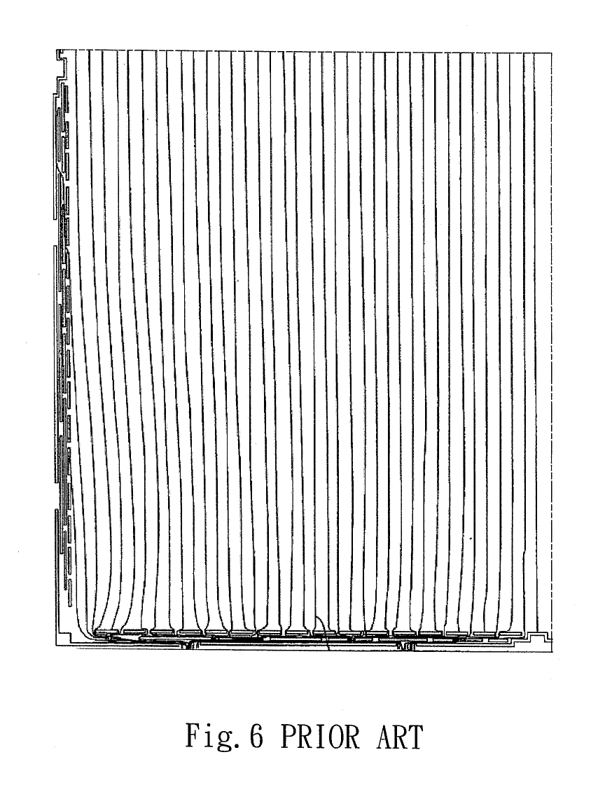

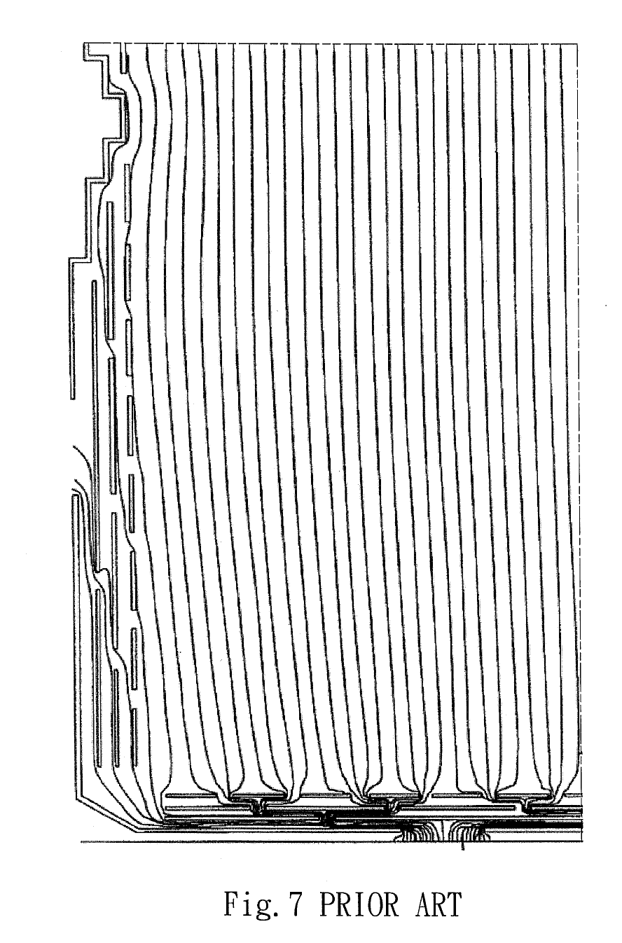

Refer to FIG. 5 a diagram showing the electric equipotential lines generated by the touch panel according to the preferred embodiment shown in FIG. 3. FIG. 5 shows the distribution of the electric equipotential lines 51 generated in one corner of the touch panel 10. The more uniform the distribution of the electric equipotential lines 51, the better the linear response of the touch panel 10. In FIG. 5, the area encircled by the dotted line is an edge region 50. In general, the more uniform the distribution of the electric equipotential lines 51 in the edge region 50, the better the linear response of the touch panel 10. In comparison with the prior arts, the distribution of the electric equipotential lines in the edge region of the U.S. Pat. No. 6,781,579 (shown in FIG. 6) and the distribution of the electric equipotential lines in the edge region of the U.S. Pat. No. 4,198,539, No. 4,293,734 and No. 4,371,746 (shown in FIG. 7) are all inferior to that of the present invention.

If the electric equipotential line 51 at the lower left corner in FIG. 5 can get more closely to a reference line 60, it is thought to be located at a more perfect position. If the electric equipotential line 51 deviates from the reference line 60, the error gets greater. Compared with the electric equipotential lines of the prior arts at the lower left corners of FIG. 6 and FIG. 7, the electric equipotential line 51 of the present invention is closer to the reference line 60. Therefore, the linear response of the present invention is superior to that of the prior arts.

In conclusion, the present invention improves the linear response of the electric equipotential lines 51 via modifying the equations for the arrangements in the conductive silver traces 40 and installing an additional conductive silver trace 40 between the conductive silver traces L₂ and L₄, whereby the linearity of the electric field distribution in the touch panel 10 is improved, the outer frame of the touch panel 10 is minimized, and the print error occurring in printing the conductive silver traces 40 or the uneven distribution of the ITO surface impedance is counterbalanced.

The preferred embodiments described above are only to exemplify the present invention but not limit the scope of the present invention. Therefore, any equivalent modification or variation according to the spirit of the present invention is to be also included within the scope of the present invention, which is based on the claims stated below.

From the above description, it is proved that the present invention has improvements over the prior arts and that the present invention indeed possesses novelty and non-obviousness and meets the conditions for a patent. Therefore, the Inventors file the application for a patent. It will be appreciated if the patent is approved fast.

What is claimed is:

1. A touch panel with an improved electrode pattern, comprising:
an insulating substrate;
a conduction layer formed on the surface of said insulating substrate; and
an electrode pattern formed on the surface of said conduction layer and arranged along the edges of said touch panel,
wherein said electrode pattern further comprises rows of parallel conductive silver traces, and each said conductive silver trace has a plurality of electrodes having an identical length and equidistantly spaced, and
wherein let X denote the total number of the rows of said conductive silver traces, and let Lₙ(n=1˜X) denotes said conductive silver traces in the sequence of from the one near the center of said touch panel toward the one far away from the center of said touch panel, and let N denote the number of said electrodes in one of said conductive silver traces, and N is determined by from Equation 1 to Equation 4:
For Lₙ₌₁, N=2^{(X-n+2)}+1 (Equation 1)
For Lₙ₌₂, N=2^{(X-n+1)}+3 (Equation 2)
For Lₙ₌₃, N=2^{(X-n+2)}−1 (Equation 3)
For Lₙ₌₄, N=2^{(X-n+2)}+6 (Equation 4)

2. The touch panel with an improved electrode pattern according to claim 1, wherein the width of said electrode pattern is below 2.8 mm.

3. A touch panel with an improved electrode pattern, comprising:
an insulating substrate;
a conduction layer formed on the surface of said insulating substrate; and
an electrode pattern formed on the surface of said conduction layer and arranged along the edges of said touch panel, wherein said electrode pattern further comprises rows of parallel conductive silver traces, and each said conductive silver trace has a plurality of electrodes having an identical length and equidistantly spaced, and
wherein let X denote the total number of the rows of said conductive silver traces, and let Lₙ(n=1˜X) denotes said conductive silver traces in the sequence of from the one near the center of said touch panel toward the one far away from the center of said touch panel, and let N denote the number of said electrodes in one of said conductive silver traces, and N is determined by from Equation 1 to Equation 4:
For Lₙ₌₁, N=2^{(X-n+2)}+1 (Equation 1)
For Lₙ₌₂, N=2^{(X-n+1)}+3 (Equation 2)
For Lₙ₌₃, N=2^{(X-n+2)}−1 (Equation 3)
For Lₙ₌₄, N=2^{(X-n+2)}+6 (Equation 4), and
wherein an additional conductive silver trace is formed in between said conductive silver traces L₂ and L₄ and to implement a parallel connection of said conductive silver traces L₂ and L₄.
